(19) United States
(12) Patent Application Publication
(10) Pub. No.: US 2009/0134971 A1
(43) Pub. Date: May 28, 2009

(54) ELECTRONIC DEVICE AND CONTROL METHOD THEREOF

(75) Inventors: LUNG DAI, Tu-Cheng (TW); KUN HUANG, Shenzhen City (CN)

Correspondence Address: PCE INDUSTRY, INC.;ATT. Steven Reiss, 458 E. LAMBERT ROAD, FULLERTON, CA, 92835, US

(73) Assignees: HONG FU JIN PRECISION INDUSTRY (ShenZhen) CO., LTD., Shenzhen City (CN); HON HAI PRECISION INDUSTRY CO., LTD., Tu-Cheng (TW)

(21) Appl. No.: 12/147,519

(22) Filed: Jun. 27, 2008

(30) Foreign Application Priority Data
Nov. 26, 2007 (CN) 200710202678.8

(51) Int. Cl. G05B 19/00

(52) U.S. Cl. 340/5.1; 340/825.72

(57) ABSTRACT

An exemplary electronic device is disclosed herein. The electronic device includes an instruction generator, a main processing unit, a recorder, and a storage unit. The instruction generator is configured for generating control signals in response to user's inputs to the electronic device. The main processing unit is configured for performing corresponding functions according to the control signals. The recorder is configured for reproducing operation information comprising information of the control signals. The storage unit is used for storing the operation information.

### BACKGROUND

1. Field of the Invention

The present invention relates to electronic devices, and particularly to a household electronic device and its control method.

2. Description of Related Art

Most household electronic devices, such as televisions, set-top boxes (STB), disc players, etc. can perform various functions according to user's inputs via some user interfaces such as keyboards, displays, and remote controllers. Take a remote controller of a television as an example, the remote controller generates modulated wireless signals in response to the user's inputs, and then transmits the modulated wireless signals to the television. The television then performs corresponding functions according to the modulated wireless signals.

During operation, the household electronic devices may malfunctions. Troubleshooting the causes of the malfunctions is a real challenge, because the malfunctions can be due to improper user's inputs. However, it is difficult to know exactly if the malfunction is due to user's inputs or hardware/software problems. Thus, it is difficult to maintain and/or repair the household electronic devices sometimes.

Therefore, an improved electronic device and its control method are needed to address the aforementioned deficiency and inadequacies.

### SUMMARY

An exemplary electronic device is disclosed herein. The electronic device includes an instruction generator, a main processing unit, a recorder, and a storage unit. The instruction generator is configured for generating control signals in response to user's inputs to the electronic device. The main processing unit is configured for performing corresponding functions according to the control signals. The recorder is configured for reproducing operation information comprising information of the control signals. The storage unit is used for storing the operation information. A related control method of an electronic device is also provided.

Other advantages and novel features of the present invention will become more apparent from the following detailed description of preferred embodiment when taken in conjunction with the accompanying drawings.

### BRIEF DESCRIPTION OF THE DRAWINGS

FIG. 1 is a schematic diagram of an electronic device in accordance with an exemplary embodiment, the electronic device is a television including a remote controller.

FIG. 2 is a block diagram of the electronic device of FIG. 1.

FIG. 3 is a schematic diagram showing the electronic device of FIG. 1 in operation.

FIG. 4 is a flow chart of a control method of an electronic device in accordance with an exemplary embodiment.

### DETAILED DESCRIPTION OF THE EMBODIMENTS

References will now be made to the drawings to describe exemplary embodiments of the present electronic device and its control method.

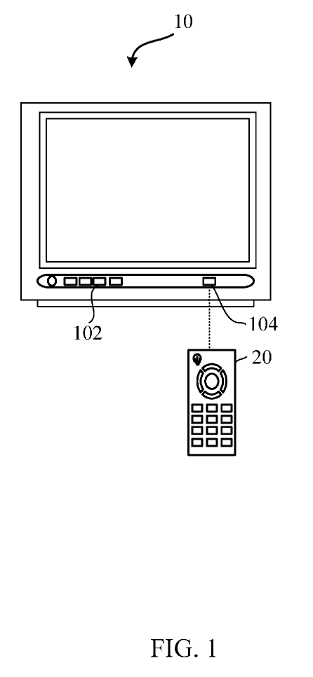

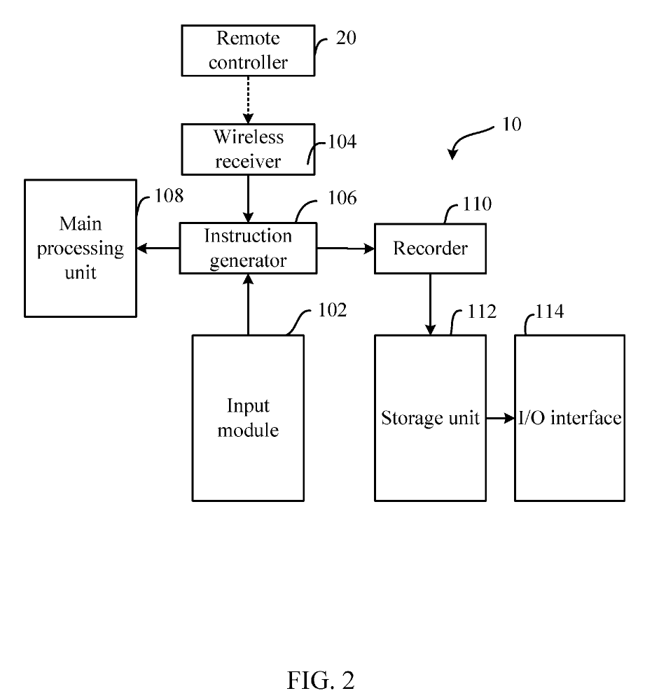

Referring to FIGS. 1 and 2, an electronic device 10 in accordance with an exemplary embodiment is shown. The electronic device 10 records operation information corresponding to user's inputs. The operation information can be viewed, and used to identify if malfunctions of the electronic device 10 are due to improper user's inputs. In the exemplary embodiment, the electronic device 10 is a television controllable by a remote controller 20. The electronic device 10 further includes an input module 102, a wireless receiver 104, an instruction generator 106, a main processing unit 108, a recorder 110, a storage unit 112, and an input/output (I/O) interface 114.

The remote controller 20 is used for generating modulated wireless signals in response to the user's inputs. The remote controller 20 is a wireless handheld device with an array of buttons for adjusting various settings of the electronic device 10, such as television channel, track number, and volume. In detail, the remote controller 20 detects the user's inputs, generates the modulated wireless signals accordingly, and transmits the modulated wireless signals to the electronic device 10. The wireless signals may be modulated infrared ray signals, radio signals, or bluetooth signals.

The wireless receiver 104 is configured for receiving the modulated wireless signals, and decoding the modulated wireless signals into first coded signals correspondingly.

The input module 102 acts as an inner controller relative to the remote controller 20. In the exemplary embodiment, the input module 102 includes a plurality of buttons for generating second coded signals in response to the user's inputs. The first coded signals are be the same as the second coded signals when the input module 102 receives the same user's inputs as those the remote controller 20 receives. In other embodiment, the input module 102 could be a touch pad, a scroll wheel, or a voice input module.

The instruction generator 106 is used for generating control signals corresponding to the first and second coded signals. The main processing unit 108 is configured for performing corresponding functions in response to the control signals, such as changing television channels of the television, adjusting volume, etc.

The recorder 110 is configured for reproducing the operation information according to the control signals. In detail, the recorder 110 replays operation information, and records creation time of the control signals sequentially. The operation information may include identification of the control signals, purposes/functions of the control signals, and result of the control signals, such as “a channel changing signal, used for changing the television channel from channel 3 to Channel 1, the television channel changed from channel 3 to channel 1.” The storage unit 112 is used for storing the operation information, the creation time of the control signals.

The I/O interface 114 is configured for transmitting operation information stored in the storage unit 112 to external devices.

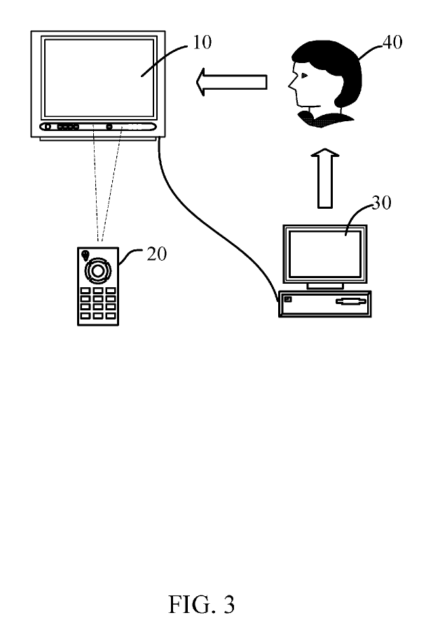

Referring also to FIG. 3, in operation, the electronic device 10 records and stores the operation information corresponding to the received inputs. The user's information can be viewed by connecting a computer 30 to the electronic device 10 when the electronic device 10 has malfunctions. The source or sources of the malfunctions can be found more easily than that of the conventional electronic devices. Maintenance and servicing time of the electronic device 10 can also be shortened.

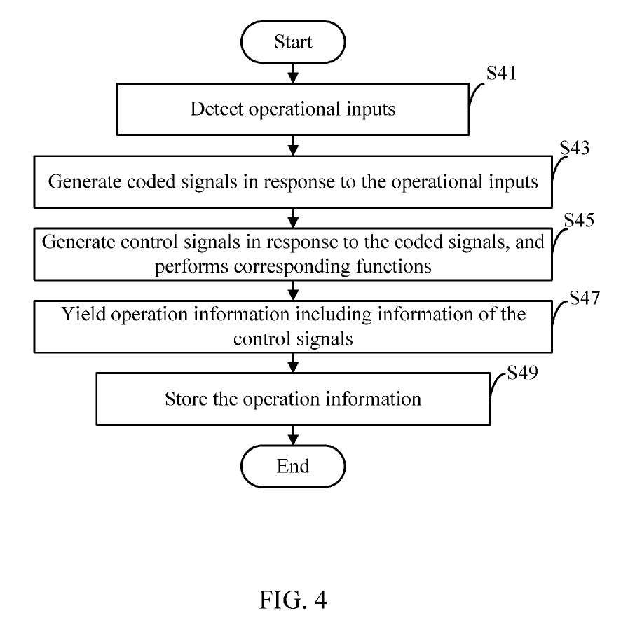

Referring to FIG. 4, a flow chart of a control method of the electronic device 10 is shown. The control method includes the following steps.

In step S41, the electronic device 10 detects user's inputs of a user via the remote controller 20 wirelessly or the inner input module 102 directly.

In step S43, the electronic device 10 generates coded signals (the first or the second coded signals) in response to the user's inputs. When the user's inputs are detected via the remote controller 20, the first coded signals are generated. When the operations are detected via the inner input module 102, the second coded signals are generated.

In step S45, the electronic device 10 generates control signals in response to the first and second coded signals, and performs corresponding functions according to the control signals.

In step S47, the electronic device 10 reproduces operation information, and records creation time and sequences of the control signals. As described above, the operation information may include the identification of the control signals, purposes/functions of the control signals, and result of the control signals.

In step S49, the electronic device 10 stores the operation information, the creation time of the control signals in a readable storage unit 112.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. An electronic device, comprising:
an instruction generator for generating control signals in response to user's inputs to the electronic device;
a main processing unit for performing corresponding functions according to the control signals;
a recorder for reproducing operation information comprising information of the control signals; and
a storage unit for storing the operation information.

2. The electronic device as described in claim 1, further comprising an input/output interface for outputting the operation information stored in the storage unit.

3. The electronic device as described in claim 1, further comprising a remote controller for detecting the user's inputs, and generating modulated wireless signals corresponding to the user's inputs.

4. The electronic device as described in claim 3, further comprising a wireless receiver for receiving the modulated wireless signals, and decoding the modulated wireless signals into first coded signals.

5. The electronic device as described in claim 4, wherein the modulated wireless signals are one of the followings: modulated infrared ray signals, radio signals, and bluetooth signals.

6. The electronic device as described in claim 1, further comprising an input module for detecting the user's inputs, and generating second coded signals correspondingly.

7. The electronic device as described in claim 1, wherein the recorder is further used for recording creation time of the control signals.

8. The electronic device as described in claim 1, wherein the electronic device is a television.

9. The electronic device as described in claim 1, wherein the operation information comprises at least one of the following information: identifications, purposes, functions, and results of the control signals.

10. A control method of an electronic device, comprising:
generating control signals in response to user's inputs;
performing corresponding functions according to the control signals;
reproducing operation information comprising information of the control signals; and
storing the operation information.

11. The control method of an electronic device as claimed in claim 10, wherein the user's inputs are received by a remote controller.

12. The control method of an electronic device as claimed in claim 10, wherein the user's inputs are received by an inner input module of the electronic device.

13. The control method of an electronic device as described in claim 10, wherein the operation information comprises at least one of the following information: identifications of the control signals, purposes of the control signals, functions of the control signals, and results of the control signals.

14. The control method of an electronic device as described in claim 10, wherein the operation information is stored in a readable storage unit of the electronic device.
